(19) United States
(12) Patent Application Publication
(10) Pub. No.: US 2014/0255274 A1
(43) Pub. Date: Sep. 11, 2014

(54) Method of printing location markings on surfaces for microscopic research

(71) Applicant: Mimi J. Yao, San Diego, CA (US)

(72) Inventor: Mimi J. Yao, San Diego, CA (US)

(21) Appl. No.: 13/791,787

(22) Filed: Mar. 8, 2013

(51) Int. Cl. B41M 3/00

(52) U.S. Cl. CPC B41M 3/00
USPC 422/547; 101/483

(57) ABSTRACT

Disclosed are devices and methods of printing location marking designs on various substrate surfaces for use in microscopic research. A preferable embodiment of the method comprises the steps of: designing a pattern of lines and symbols; transferring the pattern to a transparent film; placing the transparent film on a photopolymer plate; exposing the transparent film and the photopolymer plate to ultraviolet light wherein the pattern is transferred to the photopolymer plate; and using a pad printing machine to ink print the pattern from the photopolymer plate to a substrate. A preferable embodiment of the device is comprised of a substrate, an ink-printed pattern of lines and symbols on said substrate; and an orienting device that allows users to ascertain the directional orientation of the substrate without the use of magnification.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention

The present invention generally relates to methods of printing configurations of ink on surfaces used in microscopic biomedical research.

2. Background

The background information discussed below is presented to illustrate the novelty and utility of the Applicant's invention.

Microscopy is the field of using microscopes to view objects that cannot be seen by the unaided eye. Microscopy involves the passing of visible light through a sample placed on a transparent surface which is then magnified and viewed through a lens or captured digitally. Location markers on the transparent surfaces are often useful to locate, observe, and count the objects of interest. These markers are especially useful in biomedical research where doctors, scientists, and other skilled technicians frequently work with microscopic cells, bacteria colonies, et cetera.

There are a number of existing techniques for producing location marker designs on surfaces. Unfortunately, these techniques suffer from numerous limitations in their methods when applied in scientific research. These shortcomings include an inability to apply a design on certain surfaces, inconsistencies in mass production, visibility issues, excessive costs, and the involvement of long, time-consuming production processes.

There have been some notable attempts to address the aforementioned problems, however, they have not taken the approach of the embodiments of the present application or are inadequate for a variety of reasons. For example, U.S. Pat. No. 4,415,405 (published Aug. 15, 1983) to Ruddle teaches a method of printing location markings on surfaces for use in microscopic research by engraving a glass surface with acid while utilizing a photoresist stencil. While engraving is an effective method for etching grid patterns on glass microscope slides or coverslips, this method cannot be used on other frequently used application substrates. Additionally, few acids have the properties to engrave a grid pattern into plastic surfaces, which are commonly used in scientific research because certain types of cells cannot grow on glass surfaces.

Engraving also produces visibility issues. The visibility of the etched grid pattern is often blocked by growing cells that converge into masses. Furthermore, when using a microscope that utilizes a fluorescent light source, the etched grid becomes invisible as there is no transmission of light.

Another example is taught by U.S. Pat. No. 5,928,858 (published Jul. 27, 1999) to Chao that describes a method of producing a Petri dish with a gridded pattern on a transparent sticker. The sticker has a grid configuration and can be put on the bottom of a Petri dish to serve as a method of tracking observed objects during scientific study. While this gridded sticker is an effective locator on many substrates including glass and plastic, the sticker often falls off of the Petri dish surface when, for example, put into an incubator that reaches high humidity that can loosen the sticker's substrate backing. Moreover, this type of grid application is ineffective for locating cells in fluorescent study.

Another example is taught by U.S. patent application Ser. No. 11/921,641 (published Jul. 9, 2009) to Constantino that describes a method utilizing a fluorescent resin that is cured with a two-photon photopolymerization technique. Although the locator marks of a fluorescent, photopolymerizable resin can be seen under a fluorescent microscope, there are several limitations regarding this method. First, this method is inconsistent in mass production attributed to the manual steps used in its production procedure, such as adding a drop of resin on the surface of the substrate. Second, the thickness of the resin must be controlled in accordance with how long the laser stays in one place which can lead to some parts of the design having a thicker polymerized resin than others. Third, the thickness of the substrate is limited because a thick substrate used with this method can cause diffraction of the laser which reduces the resolution and quality of the cured resin design. Moreover, the creation of a design on a single surface requires approximately 2-20 minutes depending on the intricacies of the design. This method also requires costly two-photon microscopes and other related machines.

While each of these attempts is noteworthy, current methods of printing location markings on surfaces for use in microscopic research fail to adequately address the inability to apply a design on certain surfaces, inconsistencies in mass production, visibility issues, excessive costs, and the involvement of long, time-consuming production processes. There is therefore a need for an improved, low-cost, simple, high-throughput method for printing location markings for use in microscopic research that solves these limitations.

### SUMMARY OF THE INVENTION

Accordingly, it is an object of the present invention to provide a method of printing locator marks that can be used for observing and locating microscopic objects or for performing assays of microscopic objects.

It is another object of the present invention to provide a method of printing locator marks that can be used under both regular and fluorescent light sources.

It is another object of the present invention to provide a method of printing locator marks on a variety of substrates not limited to glass.

It is yet another object of the present invention to provide a method of printing locator marks on substrates that can be easily printed on only one side, such as a Petri dish.

It is yet still an object of the present invention to provide a method of printing locator marks without having the locator marks block the visibility of the objects of interest, or having the objects of interest block the visibility of the locator marks.

Another objective of the present invention to incorporate an orientating device made up of an asymmetric configuration of lines into the design of the location markings to allow users to ascertain the orientation of the substrate without the aid of magnification.

Another object of the present invention is to provide a low-cost, high-throughput, simple manufacturing method of printing locator marks on surfaces used for observing and locating microscopic objects or for performing assays of microscopic objects.

Another object of the present invention is to provide a method of printing locator marks on surfaces for use in microscopic research. In a preferable embodiment, the method comprises the steps of designing and generating a configuration of lines with an optional alphanumeric system onto a transparent film; placing the transparent film, which acts as a positive, on top of a photopolymer plate; exposing the apparatus (transparent film and photopolymer plate) to ultraviolet light to form a negative design on the plate; attaching the plate, which acts as a stencil, to a pad printing machine; placing a substrate on a support; placing an ink cup on the pad printing machine over the negative design on the plate; and securing the plate and the ink cup on the pad printing machine. The machine then prints on the substrate surface in the following steps: (1) the plate moves forward allowing ink to go into the negative design and the design is placed directly under the pad; (2) the pad lowers to touch the ink in the negative design on the plate; (3) the pad goes back to its original position picking up the ink previously in the negative portions of the plate; (4) the plate moves back to its initial position allowing the pad to be directly above the substrate; and, (5) the pad lowers onto the surface of the substrate, completing the ink transfer from the plate to the substrate.

Other objectives of the invention will become apparent to those skilled in the art once the invention has been shown and described. These objectives are not to be construed as limitations of applicant's invention, but are merely aimed to suggest some of the many benefits that may be realized by the methods and device of the present application and with its many embodiments.

### BRIEF DESCRIPTION OF THE FIGURES

The manner in which these objectives and other desirable characteristics can be obtained is better explained in the following description and attached figures in which:

FIG. 1 is a schematic side view of a pad printer used in an embodiment of the present application with an ink cup over a negative design on a plate and a pad above a substrate.

FIG. 2 is a schematic side view of a pad printer similar to FIG. 1, except that a horizontal plate actuator is shown in a forward position, placing the pad directly above the negative design on the ink-filled plate.

FIG. 3 is a schematic side view of a pad printer similar to FIG. 2, except that a vertical pad actuator is shown in a lowered position, placing the pad on the ink in the negative design on the plate.

FIG. 4 is a schematic side view of a pad printer similar to FIG. 3, except that the vertical pad actuator is shown in an initial position, placing the pad above the negative design on the plate, with the ink transferred from the plate to the pad.

FIG. 5 is a schematic side view of a pad printer similar to FIG. 4, except that the horizontal plate actuator is shown in an initial position, with the ink cup over the negative design on the plate and the pad with the ink above the substrate.

FIG. 6 is a schematic side view of a pad printer similar to FIG. 5, except that the vertical pad actuator is shown in the lowered position, placing the pad with ink on the substrate.

FIG. 7 is a schematic side view of a pad printer similar to FIG. 1, except that the process is complete and the substrate now has a printed design.

FIG. 8 is a top view of a photopolymer plate with a microscopic grid configuration design.

FIG. 9A is a top view of a scaled embodiment of this application with a grid configuration design generated on a film transparency.

FIG. 9B is an enlarged top view of an embodiment of this application with a grid configuration design generated on a film transparency.

FIG. 9C is an enlarged top view of an embodiment of this application focusing on a small square of the grid configuration design generated on a film transparency.

FIG. 10 is an enlarged top view of an embodiment of a substrate used in this application in the form of a coverslip with a grid configuration design.

FIG. 11 is an enlarged top view of an embodiment of a substrate used in this application in the form of a microscope slide with a microscopic, fluorescent grid configuration design.

FIG. 12A is an enlarged top view of an embodiment of a grid configuration design.

FIG. 12B is an enlarged top view of an embodiment of a mirror image, grid configuration design.

FIG. 13 is a top view of an embodiment of a substrate used in this application in the form of a Petri dish with a mirror image, grid configuration design printed on the bottom surface.

FIG. 14 is a top view of an embodiment of a substrate used in this application in the form of a six-well plate with a mirror image, grid configuration design printed on the bottom surface of each well.

FIG. 15A is a top view of a grid configuration design printed with a transparent ink base onto a microscope slide, viewed under a bright-field microscope.

FIG. 15B is a top view of a grid configuration design printed with a fluorescent ink that is excited by a specific wavelength onto a microscope slide, viewed under a fluorescent microscope.

FIG. 15C is an enlarged top view of a grid configuration design similar to FIG. 15B with the addition of cells stained with a fluorescent dye grown on the microscope slide that are excited by the same wavelength as the fluorescent ink.

FIG. 16 is flow chart of a method for printing locator marks on substrate surfaces for use in microscopic research.

It is to be noted, however, that the appended figures illustrate only typical embodiments disclosed in this application, and therefore, are not to be considered limiting of its scope, for the invention may admit to other equally effective embodiments that will be appreciated by those reasonably skilled in the relevant arts. Also, figures are not necessarily made to scale.

### DETAILED DESCRIPTION OF THE PREFERRED EMBODIMENTS

In general, the preferred embodiment of the present invention is a method of printing location markings on surfaces for use in microscopic research. The method is used to print custom-designed markings with various types of ink on any type of surface used in microscopic research. The present method is designed to print the location markings in a simple, low-cost, high-throughput process that resolves the limitations of prior art. The more specific aspects of the preferable embodiments may be viewed in the drawings.

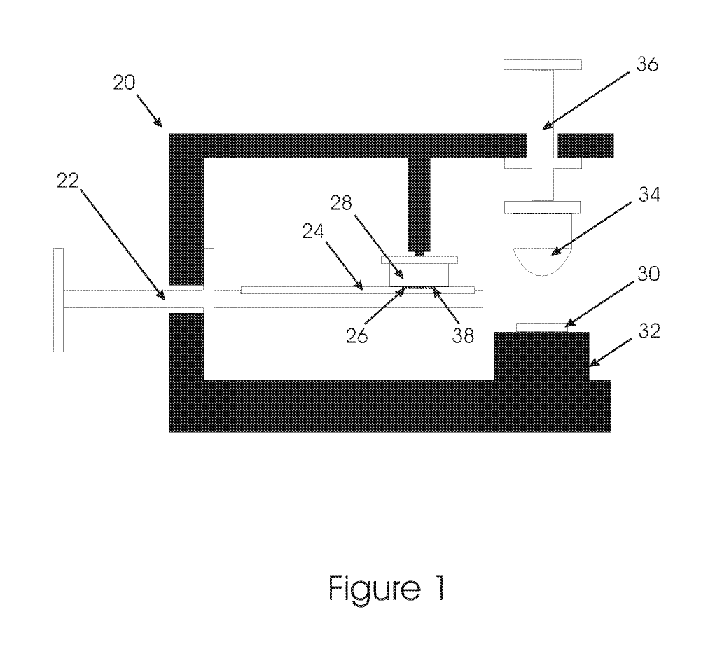

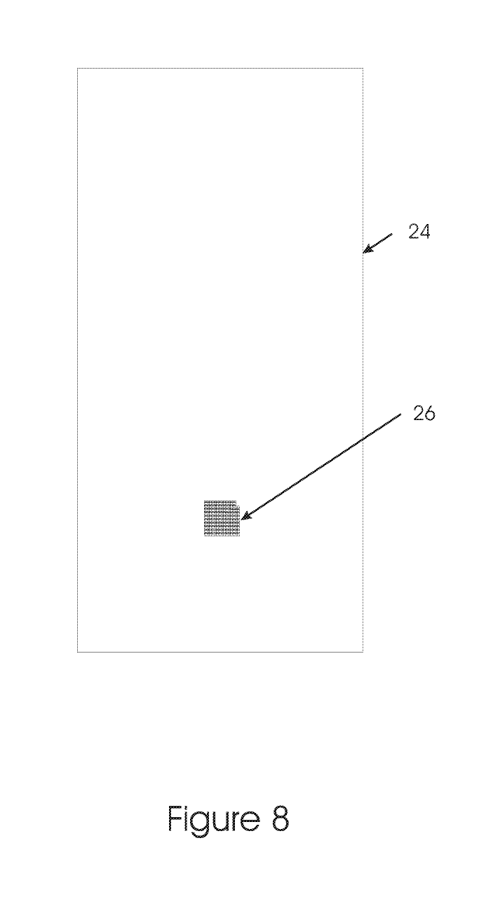

The present invention utilizes a conventional pad printing machine 20, shown schematically in FIGS. 1-7. The pad printing machine 20 contains a horizontal plate actuator 22 on which a plate 24 with a negative design 26 is attached. This negative design 26 starts as a design in software such as Adobe Photoshop, CorelDraw, or Adobe Illustrator. This design is then generated onto a transparent film in actual size. The side of the transparent film with the design is placed onto the top surface of a photopolymer plate 24. The film and plate 24 are exposed to ultraviolet light allowing the places where the film is transparent to have photosensitive resin that is polymerized, and the places where the film has the generated design to have resin that is not polymerized. The film is removed from the plate 24, which is then washed with alcohol to remove the unpolymerized resin. The alcohol is dried off with a blow dryer and the plate 24 is exposed to additional ultraviolet light to make sure it has fully polymerized. After curing, the polymerized plate 24 will have a negative design 26 in the configuration of the design on the transparent film. FIG. 8 shows a finished polymerized plate 24 with a negative design 26, ready to be used for printing.

FIGS. 1-7 illustrate one preferable embodiment of the method of the present invention. FIG. 1 is a schematic side view of the apparatus used in a preferable embodiment of the present invention in its initial state. The plate 24 is secured to the horizontal plate actuator 22 with a magnetic ink cup 28 placed on top of the negative design 26 and secured to the pad printing machine 20. Before securing the plate 24, ink is put into ink cup 28. The ink is comprised of commercially available transparent ink base, and if desired, pigment or fluorescence dye. The substrate 30 is placed on a support 32 directly below a pad 34 that is attached to a vertical pad actuator 36. Ink cup 28 is directly on the surface of plate 24 so that ink 38 fills the negative design 26.

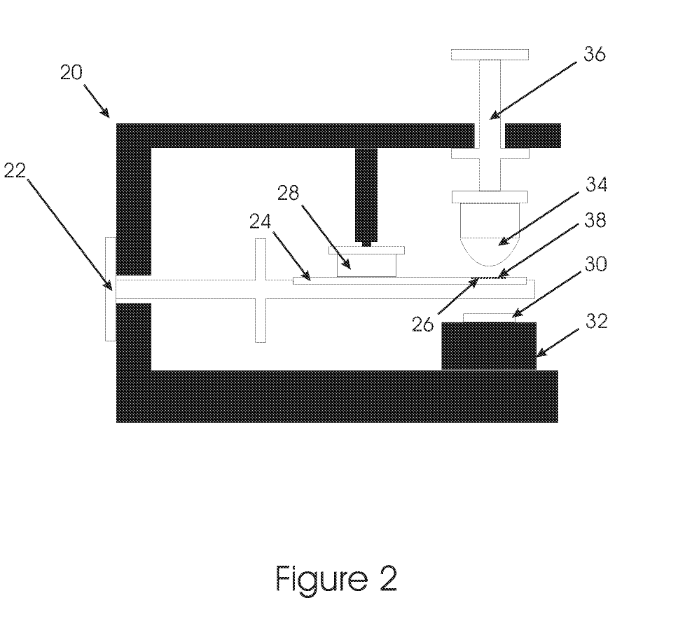

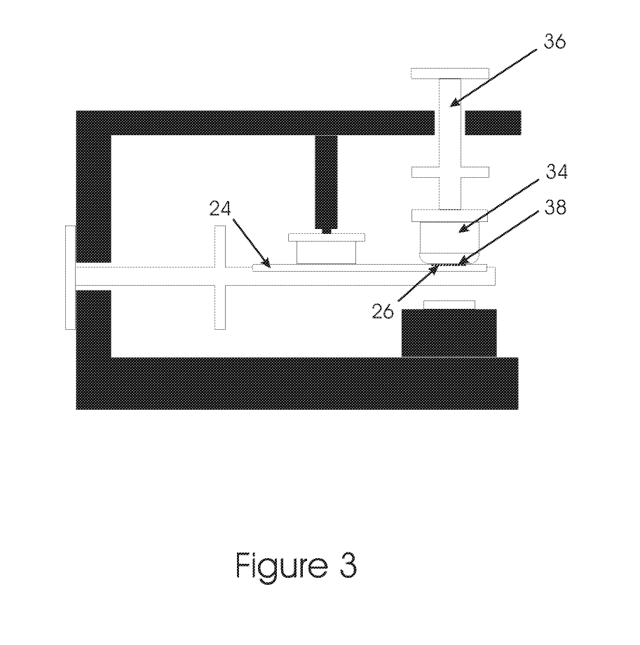

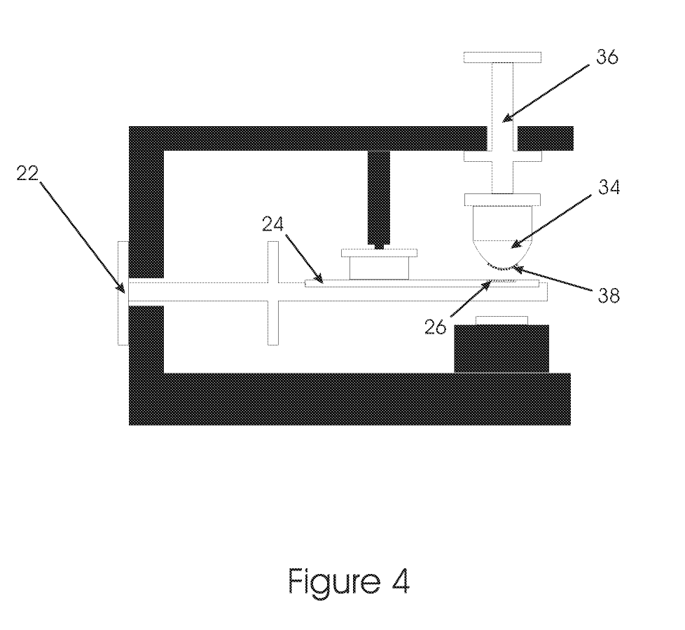

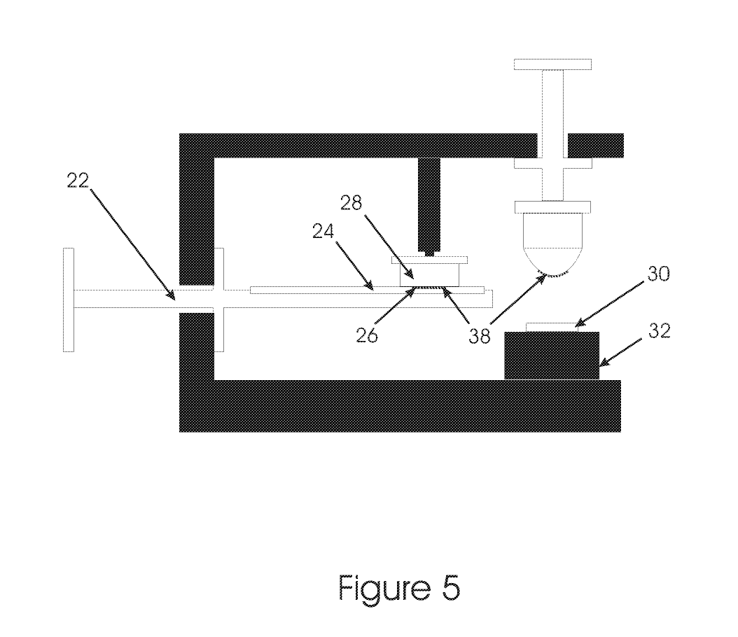

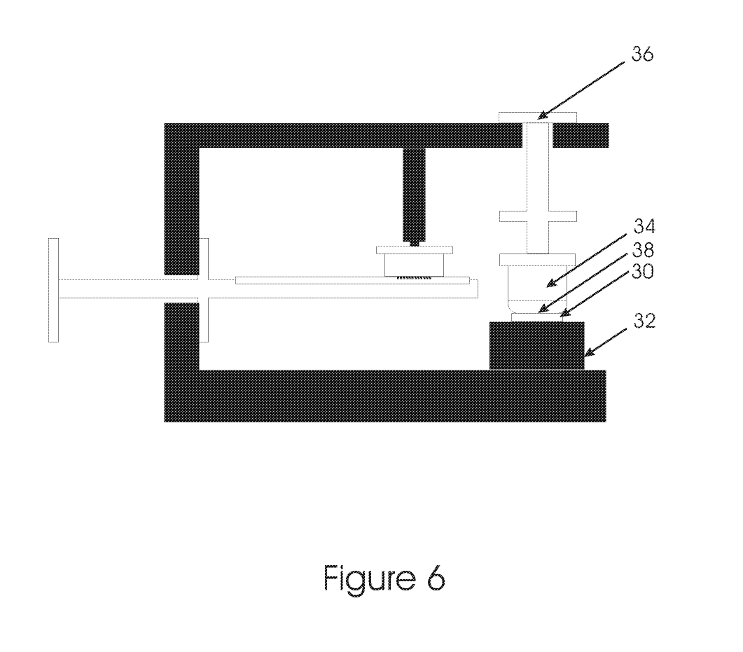

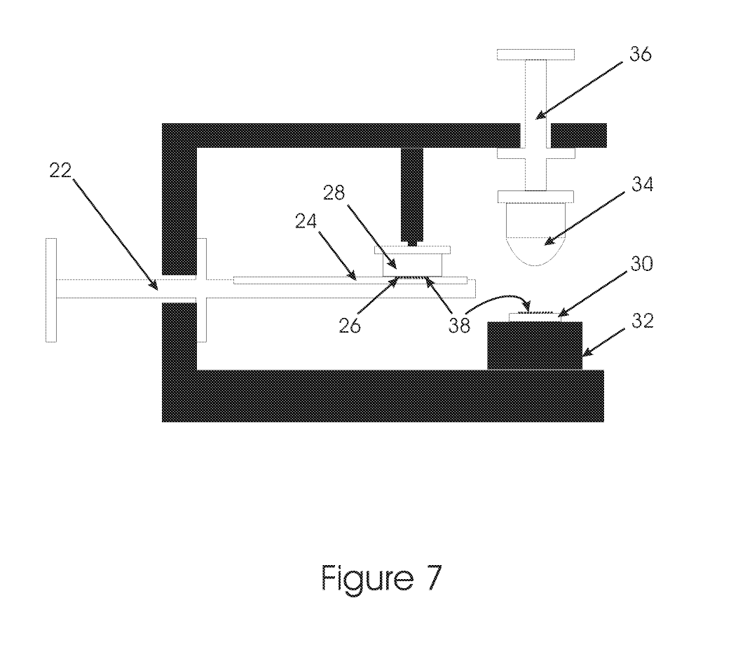

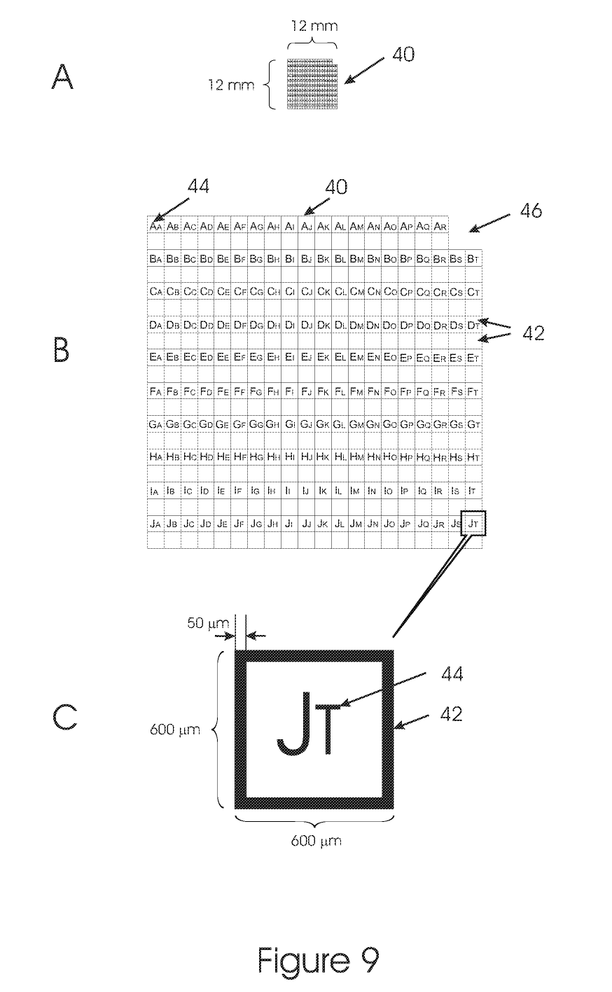

FIG. 2 is a schematic side view of the apparatus used in a preferable embodiment of the present invention wherein the horizontal plate actuator 22 is shifted into a forward position after automatic calibration of the pad printing machine 20. The pad 34 and vertical pad actuator 36 are now above the negative design 26 filled with the ink 38. Next in FIG. 3, the vertical pad actuator 36 is shifted into a lowered position. The pad 34 is now pressed down into the ink 38 in the negative design 26 on the plate 24. Subsequently, the vertical pad actuator 36 is shifted into to its initial position, and the pad 34 is raised above the plate 24 and the ink 38 is lifted from the negative design 26, as shown in FIG. 4. The ink 38 on the pad 34 is in the configuration of the negative design 26. As shown in FIG. 5, the horizontal actuator 22 is then shifted back to the initial position, placing the ink cup 28 on top of the negative design 26 which refills with ink 38. In FIG. 6, the vertical pad actuator 36 is then shifted into its lowered position and the pad 34 with the ink 38 lowers to touch the substrate 30, leaving the ink 38 on the substrate 30. Lastly, FIG. 7 shows the vertical pad actuator 36 returned to its original position and the ink 38 transferred onto the substrate 30 in the form of the negative design 26. This cycle produces a substrate with a printed design 40, such as a grid design illustrated in FIG. 9A.

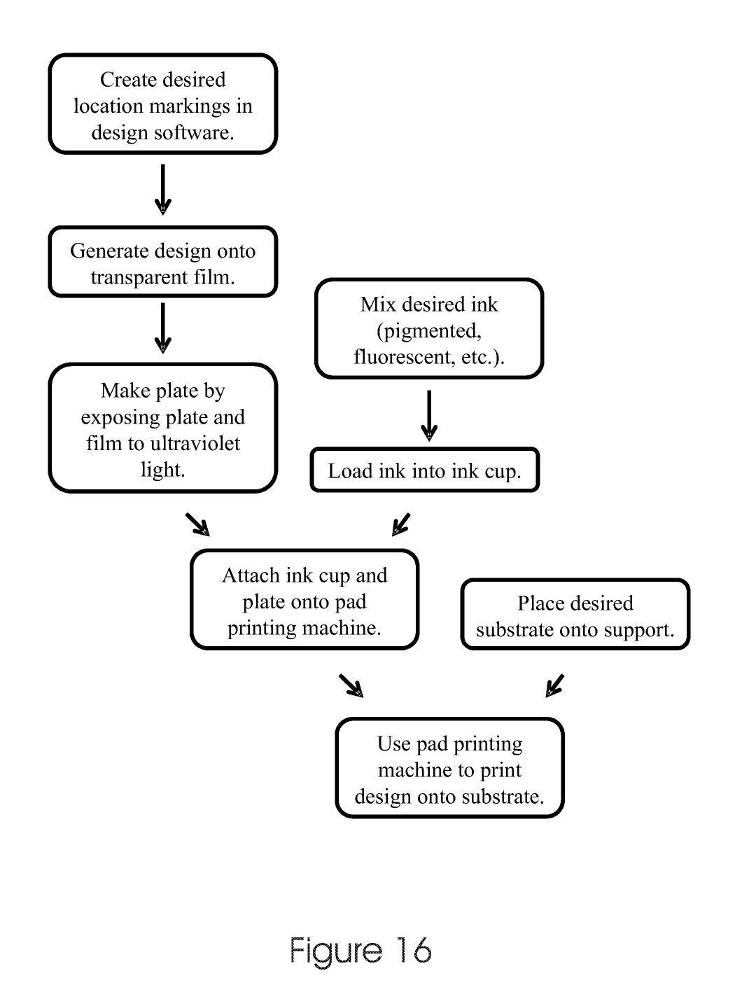

FIG. 16 is a flowchart of a method of printing location markings on surfaces for microscopic research using a preferable embodiment of the present application. The method comprises the steps of: creating desired location markings in design software; generating a design onto transparent film; making a plate by exposing the plate and film to ultraviolet light; attaching an ink cup and plate onto a pad printing machine after the desired ink has been mixed and loaded into the ink cup; using the pad printing machine to print the design onto a substrate after the substrate has been placed onto the support.

The following examples are presented to enhance the description of the invention and to illustrate four preferable embodiments, however these embodiments are not intended to limit the present invention solely to these examples.

### FIRST EXAMPLE

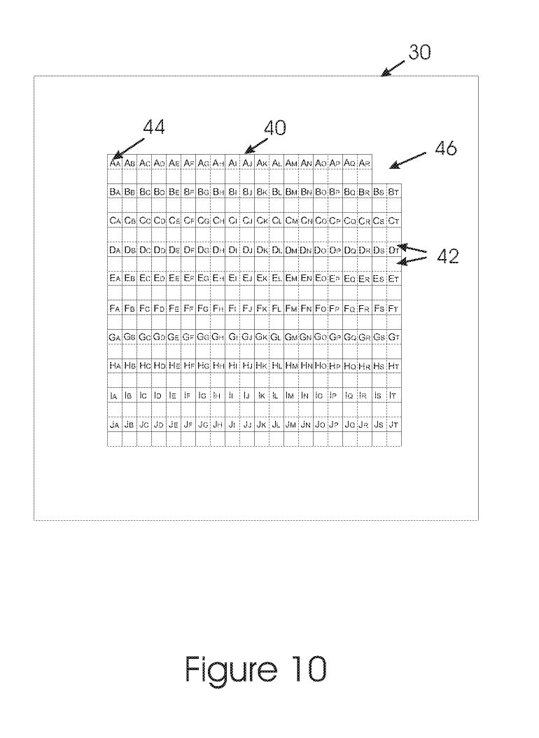

FIG. 10 is a top view of one embodiment of the present invention wherein a simple grid configuration, as illustrated in FIG. 9, is printed on a coverslip with ink. The coverslip with the ink grid configuration is made using the method of the present invention described above and illustrated in FIGS. 1-7. The printed design 40 of location markings has 396 small squares 42, with half comprising an alphabetic system 44 of marking. FIG. 9 illustrates the design generated on the film used in the printing process. The dimensions of the printed design 40 are 12 mm by 12 mm as shown in FIG. 9A, and the small squares 42 are each 600 μm by 600 μm, with a uniform 50 μm-thick, black border shown in FIG. 9C. The alphabetic system 44 is black and in Arial font.

FIG. 10 illustrates one embodiment of the present invention wherein a microscopic grid configuration with an alphabetic system is printed onto a coverslip surface made of either plastic or glass. Although the printed markings are microscopic to an unaided eye as illustrated in actual size in FIG. 9A, the printed design 40 can be seen at high resolution with an objective lens magnification of 4×, 10×, 20×, and 40×. An orientating device 46 consists of four small squares taken away from the main body of the design and placed in the upper right corner. The orienting device allows the user to orient the alphabetic markings to be right side up when viewing the printed design 40 without the aid of magnification.

In order for this grid to be right side up when in use, the printed design 40 should be printed on the upper surface of the coverslip. When the coverslip is used to cover observed objects such as cells on a microscope slide, the ink will be on the upper surface while the cells touch the lower surface of the coverslip. After the coverslip is placed on the microscope slide and cells, the small squares 42 can be utilized to visually locate and separate cells during research.

### SECOND EXAMPLE

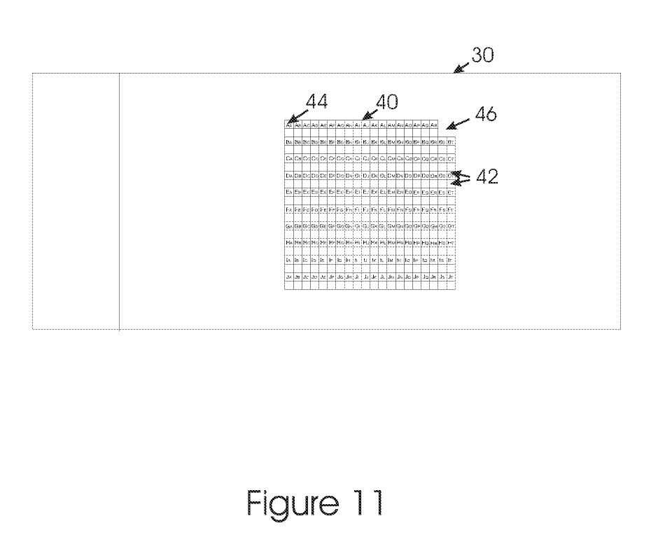

FIG. 11 is a top view of another embodiment of the present invention wherein a fluorescent grid configuration is printed on a microscope slide. The microscope slide with the fluorescent grid configuration is made using the method of the present invention described above and illustrated in FIGS. 1-7. The ink used for printing the fluorescent grid contains a transparent ink base and a fluorescent dye. A grid configuration with the design and dimensions described in FIGS. 9A-9C is used. In this embodiment, the design is printed on the upper surface of the microscope slide, the same surface on which cells are placed. The orientating device 46 is in the upper right corner to assist in identifying the orientation of the design without the aid of magnification.

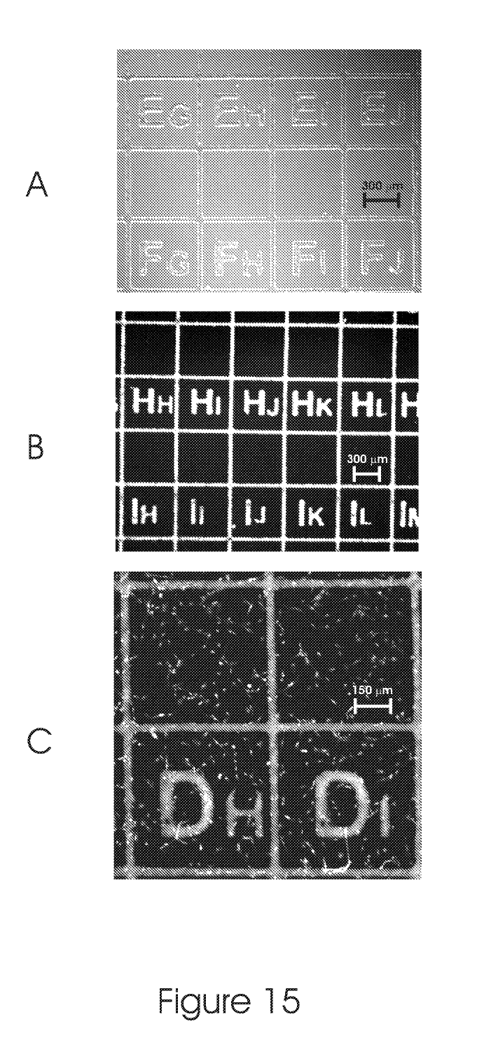

This embodiment of the present invention can be applied as fluorescent location marks or as assay compartments when studying fluorescent cells. The present invention uses fluorescent ink that allows the location marks to be visible under a fluorescent microscope. Conversely, commercially available engraved surfaces used for studying microscopic fluorescent cells are not visible under a fluorescent light source. FIG. 15A shows a microscopic photograph taken with a bright field microscope of a grid design printed on a microscope slide using fluorescent ink. FIG. 15B shows a microscopic photograph taken with a fluorescent microscope of a grid design printed on a microscope slide with fluorescent ink, where the fluorescent design emitted light when excited by a specific wavelength. FIG. 15C shows a microscopic photograph taken with a fluorescent microscope of a grid design printed on a microscope slide with fluorescent ink, with the addition of mammalian cells (white specks) growing on the slide. The mammalian cells were stained with a fluorescent dye. Under the fluorescent microscope, both the fluorescent grid design and the cells stained with fluorescent dye emitted light when excited by a specific wavelength. The cells can now be easily separated by the grid design to be located or counted.

Fluorescent locator marks are necessary when studying thick tissue slices since the thick tissue slices allow no light to be transmitted when using a microscope with a transmission light source. Frequently, the tissue slice is stained with a fluorescent dye. When using a microscope with a fluorescent light source, the dye in the tissue and the ink of the design are excited with a specific wavelength, and both the dye and the ink emit wavelengths that allow the researcher to see both the tissue slice and location markings. In this embodiment, the grid configuration design can also be used as a ruler to measure the tissue slice or serve as boxes in which the cells of the tissue can be counted. Moreover, the fluorescent markings can be used when studying cells that have converged together and have blocked the visibility of the design configuration. Using a fluorescent ink allows the grid configuration design to emit its own light when excited by a specific wavelength rather than have its visibility rely on the transmission light source of a microscope. Furthermore, the fluorescent ink can give the grid configuration design properties of visibility when necessary and invisibility when not necessary. In studying cells with no fluorescent capabilities, transmitted light can be used to see the cells under a microscope. When a grid configuration design is needed, it can be excited by certain wavelengths and appear, allowing the researcher to find the area desired. Then, the transmission light can be turned on again, allowing the fluorescent grid configuration design to disappear and allowing the user to only see the cells in that specific field. The grid configuration design can also effectively be used when cells dyed with fluorescent dye are studied by allowing the grid configuration design to be visible at all times when excited by a specific wavelength.

### THIRD EXAMPLE

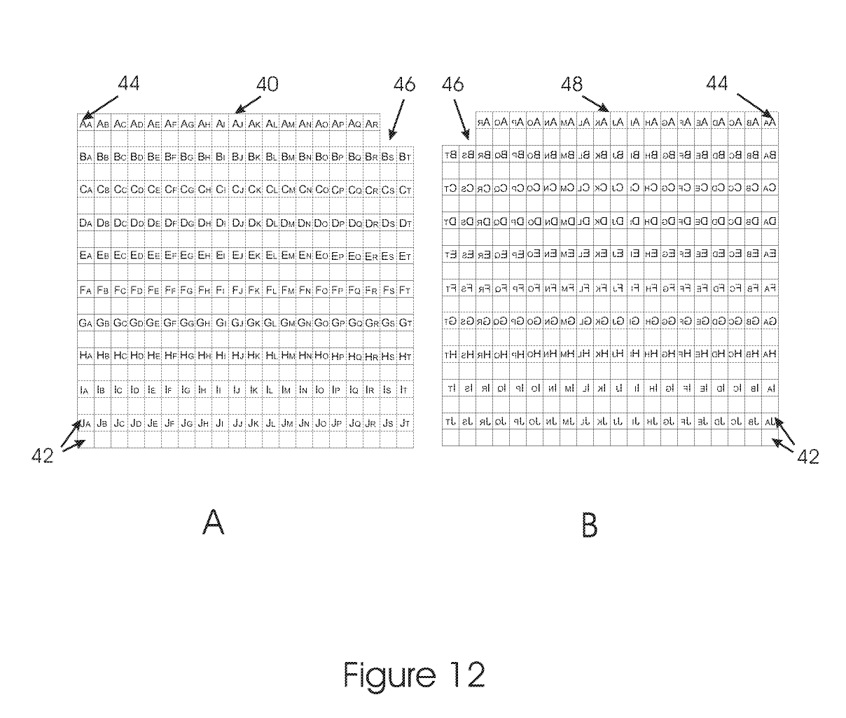

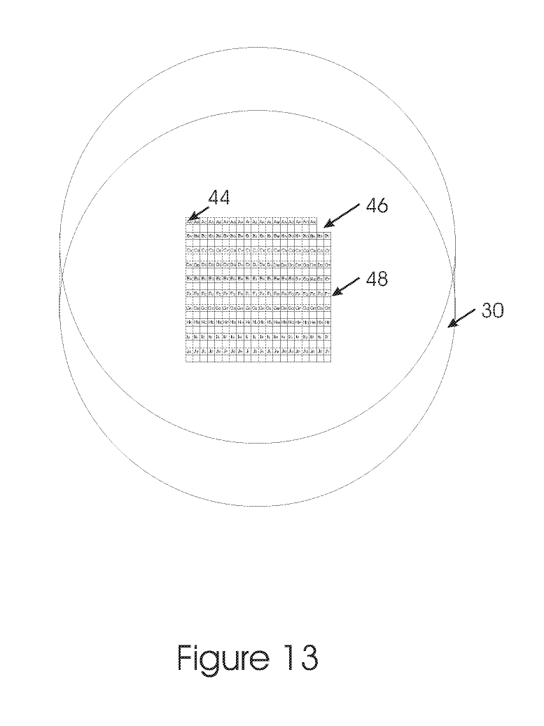

In another embodiment of the present invention, a mirror image 48 of a design shown in FIG. 12A can be printed as shown in FIG. 12B on the lower surfaces of substrates such as a Petri dish as illustrated in FIG. 13. The Petri dish with the mirror image grid configuration design is made using the method of the present invention described above and illustrated in FIGS. 1-7. The original configuration designed in the software is shown in FIG. 12B. This method allows the mirror image 48 design to be printed on the lower surface of substrate. This method allows designs to be printed on surfaces such as Petri dishes that are more easily printed on from the lower surface. The mirror image 48 design is printed on the lower surface of the bottom of the Petri dish substrate 30 allowing the right side up design 40, shown in FIG. 12A, to be seen when looking from the top view. The orientating device 46 is on the upper left corner of the mirror image 48 design to help determine the orientation of the letters 44 without the aid of magnification. When looking at the Petri dish from the top view, the orientating device 46 will be seen on the upper right corner. This method can also be used to print mirror images 48 on the lower surface of a microscope slide in order for the ink to be printed on the opposite side of where the cells are put so that the cells do not touch the ink. However, the ink is shown to be biologically inert as shown in FIG. 15C where the cells can grow even in the presence of the ink.

### FOURTH EXAMPLE

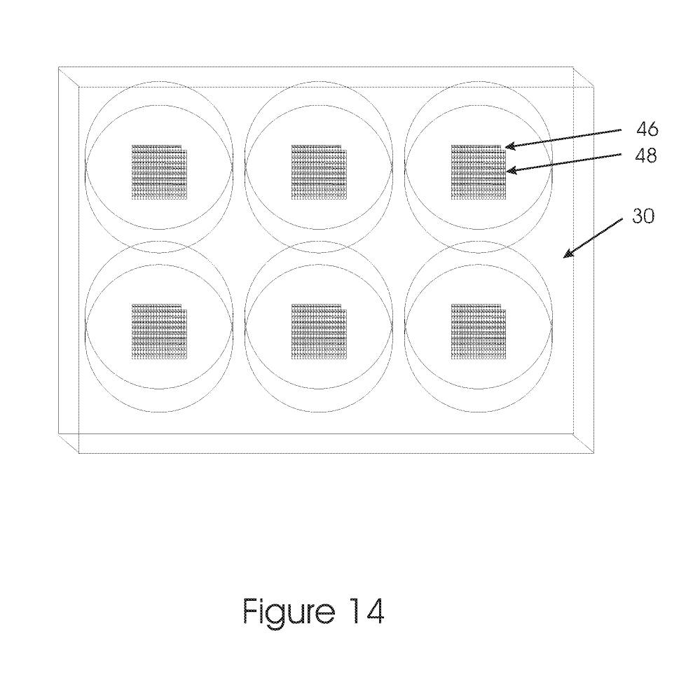

In yet another embodiment of the present invention, multiple mirror image designs 48 are printed on the lower surface of a substrate 30, such as a six-well plate illustrated in FIG. 14. The six-well plate with a fluorescent grid configuration design is made using the method of the present invention described above and illustrated in FIGS. 1-7. The design illustrated in FIG. 14 is the same design illustrated in FIGS. 9 and 12B. Because the openings of the wells are smaller than the pad 34, it is easier for the design to be printed on the lower surface where the substrate 30 is flat. Each mirror image printed design 48 has an orientating device 46 in the upper left corner but is seen in the upper right corner when looking at the well plate from the top. This configuration can be used to conduct cell assays in each well with different experimental conditions and compare the data collected from each of the six wells.

### Advantages of the Invention

One important advantage of the present invention is the capability of printing with a transparent ink base, pigmented ink, fluorescent ink, or any material that can be mixed into the ink. Transparent ink base can be used when counting observed objects where colored inks would typically block the visibility of the object. Pigmented ink can be used when a fluorescent light source is not necessary. Fluorescent ink can be used when there is a confluence of observed objects blocking the transmission light source or if a disappearing design is necessary. Other options include conducting inks, magnetic inks, or inks with bioactive materials such as DNA or protein for use in other areas of research. This option in inks allows application in studying a wide variety of objects in microscopic research.

Another advantage of the present invention is that the printing method can be applied to many different types of substrates, including the most common plastic and glass types used in microscopic research. The surfaces can be microscope slides, coverslips, Petri dishes, well plates, or any other surface that the printing pad can reach.

The most important advantage of the present invention is the simple, low-cost, and high-throughput nature of the method. The printing process takes only seconds for a substrate to be printed on, and the machinery required is relatively low-cost compared to the machinery used in previous engraving and curing resin techniques. The method can also be highly automated, which is convenient in the mass production of printed substrates.

It should be noted that FIGS. 1 through 16 and the associated description are of illustrative importance only. In other words, the depiction and descriptions of the present invention should not be construed as limiting of the subject matter in this application. The methods and devices discussed hereby are susceptible to modification without changing the overall concept of the disclosure. Additional modifications may become apparent to one skilled in the art after reading this disclosure.

1. A method of printing locator marks on surfaces for use in microscopic research comprising the steps of:
establishing a configuration of lines;
transferring the configuration of lines onto a transparent film;
placing the transparent film on a photopolymer plate;
exposing the transparent film and the photopolymer plate to ultraviolet light that produces a negative of the configuration of lines on the photopolymer plate;
attaching the photopolymer plate and an ink cup containing ink to a pad printing machine; and,
using the pad printing machine to print the design of the configuration of lines from the photopolymer plate onto a substrate.

2. The method of claim 1 wherein the configuration of lines is an alphanumeric system whereby user is aided in identifying, locating, and observing microscopic objects.

3. The method of claim 2 wherein the alphanumeric system is in a grid configuration of alphanumeric location markers that aid in the location identification of microscopic objects.

4. The method of claim 3 wherein the grid configuration contains an asymmetric orienting device that allows users to ascertain the directional orientation of the substrate without the use of magnification.

5. The method of claim 1 wherein the configuration of lines is initially designed as a mirror image of the design that will be printed on the substrate.

6. The method of claim 1 wherein the pad printing machine prints the design of the configuration of lines on the substrate's surface in the following steps:
(a) the photopolymer plate moves forward allowing ink to go into the negative configuration of lines;
(b) the photopolymer plate is placed directly under a pad of the pad printing machine;
(c) the pad lowers to touch the ink in the configuration of lines on the photopolymer plate:
(d) the pad goes back to its original raised position after picking up the ink previously in the negative portions of the configuration of lines on the photopolymer plate;
(e) the photopolymer plate moves back to its original position;
(f) the pad lowers onto the surface of the substrate transferring the ink to the substrate.

7. (not entered)

8. The method of claim 1 wherein the ink used to print the configuration of lines on the substrate is comprised of a transparent ink base and a fluorescent dye that emit light when excited by a specific wavelength.

9. The method of claim 1 wherein the ink used to print the configuration of lines on the substrate is a pigmented ink, a conducting ink, a magnetic ink, or an ink with bioactive materials such as DNA or protein.

10. The method of claim 1 wherein the substrate is comprised of any of the group of materials consisting essentially of:
glass;
plastic;
silicone; or, any combination thereof.

11. The method of claim 10 wherein the substrate is from the group of materials consisting essentially of:
coverslips;
microscope slides;
Petri dishes;
well plates; or,
silicone membranes.

12. A method of printing locator marks on surfaces for use in microscopic research comprising the steps of:
establishing a pattern of lines and symbols;
transferring the pattern to a transparent film;
placing the transparent film on a photopolymer plate;
exposing the transparent film and the photopolymer plate to ultraviolet light wherein the pattern is transferred to the photopolymer plate, and,
using a pad printing machine to ink-print the pattern from the photopolymer plate to a substrate.

13. The method of claim 12 wherein the pattern is an alphanumeric system in a grid configuration of alphanumeric location markers that aid in the location identification of microscopic objects.

14. The method of claim 13 wherein, the grid configuration contains an asymmetric orienting device that allows users to ascertain the directional orientation of the substrate without the use of magnification.

15. The method of claim 12 wherein the pattern is initially designed as a mirror image of the design that will be printed on the substrate.

16. The method of claim 12 wherein the ink used to print the pattern on the substrate is a transparent ink, a fluorescent ink, a pigmented ink, a conducting ink, a magnetic ink, or an ink with bioactive materials such as DNA or protein.

17. The method of claim 12 wherein the substrate is from the group of materials consisting essentially of:
glass;
plastic;
silicone; or,
a combination thereof.

18. A device used in microscopic research comprising:
a substrate;
an ink-printed pattern of lines and symbols on said substrate; and,
wherein the printed pattern of lines and symbols is an alphanumeric system in a grid configuration of alphanumeric location markers that aid in the location identification of microscopic objects.

19. The device of claim 18 wherein an asymmetric orienting device allows users to ascertain the directional orientation of the substrate without the use of magnification.

20. The device of claim 19 wherein the orienting device is comprised of four adjacent squares, forming a larger square, of the grid configuration which are taken away from the grid configuration and printed in the upper right corner of the substrate.
